(19) United States
(12) Patent Application Publication
(10) Pub. No.: US 2018/0197258 A1
(43) Pub. Date: Jul. 12, 2018

(54) MULTI-POINT POSITIONING TRAVEL RECORDING AND PLANNING SYSTEM

(71) Applicant: WANIN INTERNATIONAL CO., LTD., Taichung (TW)

(72) Inventor: Cheng-Hao Hsiao, TAICHUNG (TW)

(21) Appl. No.: 15/402,538

(22) Filed: Jan. 10, 2017

(51) Int. Cl. G06Q 50/14; G06Q 50/00; H04W 4/02

(52) U.S. Cl. CPC G06Q 50/14; H04W 4/02; G06Q 50/01

(57) ABSTRACT

A multi-point positioning travel recording and planning system includes a check-in module, a storage module, a statistics module, an editing module and a publishing module. The check-in module captures first location information and a second location information at a first time point and a second time point, respectively. The first time point is combined with the first location information to form first check-in information, and the second time point is combined with the second location information to form second check-in information. The storage module stores the first check-in information and the second check-in information. The statistics module combines the first check-in information and the second check-in information to form travel information. The editing module edits the travel information that is then published by the publishing module. Thus, while viewing positions of tourist attractions, time arrangements can be confirmed at the same time.

### FIELD OF THE INVENTION

The present invention relates to a recording and planning system, and particularly to a multi-point positioning travel recording and planning system.

### BACKGROUND OF THE INVENTION

With the progressing technologies, social networks provide innovated approaches for information exchange and sharing, such that various types of information is constantly forwarded and shared through social networks to become widely known. Based on the same topics, hobbies, learning experiences, work experiences or travel destinations, people with the same interests and experiences may be gathered to share things, e.g., travel notes, and associated records and photographs can be uploaded and be shared.

Taking traveling for example, many people upload travel itineraries to the Internet for others to browse and refer to. In these travel notes, photos are often accompanied by text descriptions, in a sequence of one attraction after another. Although such type of travel notes allow others to quickly learn the order of attractions visited, because these travel notes are written afterwards, the time of visiting is usually indicated merely by morning, afternoon and evening/night instead of clearing stating specific time points. For travelers traveling with infants or elderly, the duration of time needed for respective attractions cannot be easily controlled, and further planning and studying need to be conducted.

One current common sharing means is through checking-in on the Facebook, e.g., the U.S. Pat. No. 8,150,844 disclosing “Location Ranking Using Social Graph Information”. When a user is to check-in, the system detects a current position and nearby landmarks of the user, and the user is provided with a list of locations according to factors such as respective distances between the current location and the nearby landmarks. While checking-in, photographs and text descriptions may be added for friends or strangers to browse on the Internet. However, such check-in method is a single-point check-in; that is, the user may perform a first check-in once having arrived at a destination A, and then a second check-in once having arrived at a destination B. As such, since others respectively see that the users has visited the destination point A and the destination point B at two different time points, it is less intuitive for one to associate the above travel as arrangements of different visiting sequences of a same journey.

Therefore, there is a need for a solution that confirms time arrangements while viewing graphic and text descriptions.

### SUMMARY OF THE INVENTION

It is a primary object of the present invention to solve the issue of the incapability of confirming time arrangement while viewing graphic and text descriptions.

To achieve the above object, the present invention provides a multi-point positioning travel recording and planning system. The multi-point positioning travel recording and planning system includes a check-in module, a storage module electrically connected to the check-in module, a statistics module electrically connected to the storage module, an editing module electrically connected to the statistics module, and a publishing module electrically connected to the editing module. The check-in module includes a positioning unit. The positioning unit captures first location information and second location information at a first time point and a second time point, respectively. The first time point is combined with the first location information to form first check-in information. The second time point is combined with the second location information to form second check-in information. The first time point is earlier than the second time point. The storage module stores the first check-in information and the second check-in information. The statistics module includes a check-in information selecting unit. The check-in information selecting unit selects the first check-in information and the second check-in information. The statistics module combines the first check-in information and the second check-in information according to sequences of the first time point and the second time point to form travel information. The editing module edits the travel information, which is then published at a type of software by the publishing module.

In conclusion, by combining the first check-in information and the second check-in information to form the travel information, the present invention is capable of simultaneously confirming time arrangements while viewing positions of attractions, thereby providing more accurate time points and locations for others to browse and refer to.

### BRIEF DESCRIPTION OF THE DRAWINGS

FIG. 1 is a function block diagram of the present invention;

FIG. 2 is a flowchart according to a first embodiment of the present invention;

FIG. 3A to FIG. 3C are schematic diagrams of an application process according to the first embodiment of the present invention;

FIG. 4 is a flowchart according to a second embodiment of the present invention; and

FIG. 5A to FIG. 5D are schematic diagrams of an application process according to the second embodiment of the present invention.

### DETAILED DESCRIPTION OF THE PREFERRED EMBODIMENTS

Details and technical contents of the present invention are given with the accompanying drawings below.

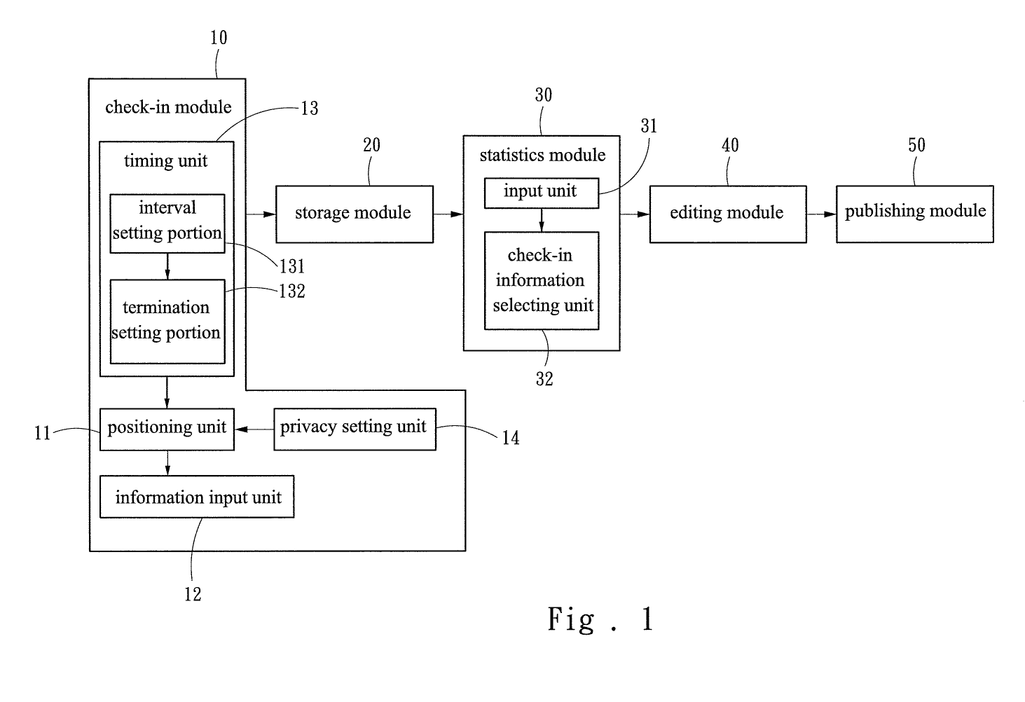

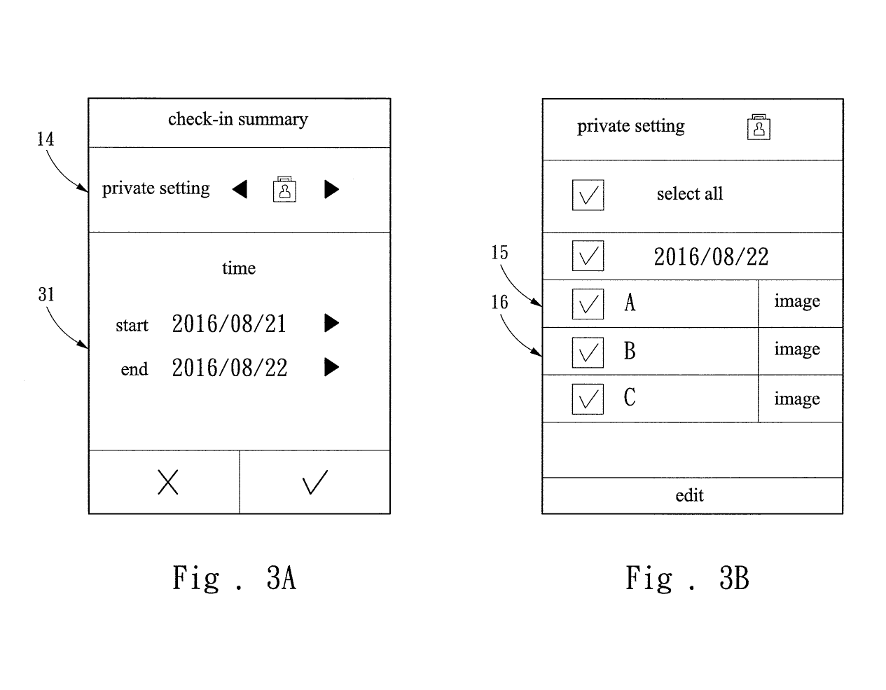

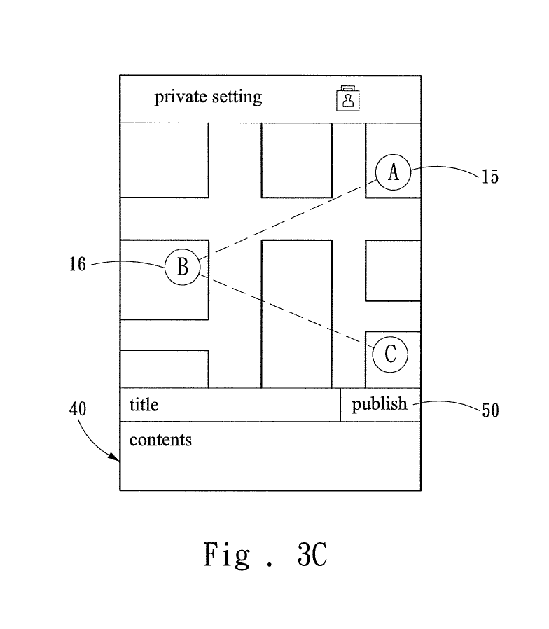

Referring to FIG. 1, a multi-point positioning travel recording and planning system of the present invention may be installed on a portable device such as a mobile phone or a tablet computer, and includes a check-in module 10, a storage module 20 electrically connected to the check-in module 10, a statistics module 30 electrically connected to the storage module 20, an editing module 40 electrically connected to the statistics module 30, and a publishing module 50 electrically connected to the editing module 40. The check-in module 10 includes a positioning unit 11. The positioning unit 11 captures first location information at a first time point, and then captures second location information at a second time point, wherein the first time point is earlier than the second time point. The check-in module 10 combines the first time point with the first location information to form first check-in information 15 (as shown in FIG. 3), and combines the second time point with the second location information to form second check-in information 16 (as shown in FIG. 3). The storage module 20 stores the first check-in information 15 and the second check-in information 16. For example, the first time point may be 8:00 in the morning, the first location information is a destination A, and the destination A is captured at 8:00 in the morning to form the first check-in information 15; the second time point may be 10:00 in the morning, the second location information is a destination B, and the destination B is captured at 10:00 in the morning to form the second check-in information 16.

The statistics module 30 includes a check-in information selecting unit 32. The check-in information selecting unit 32 selects the first check-in information 15 and the second check-in information 16, and combines the first check-in information 15 and the second check-in information 16 according to sequences of the first time point and the second time point to form travel information. The editing module 40 may edit the travel information, e.g., modifying photographs or texts, to enrich the contents of the travel information. The publishing module 50 may then publish the travel information at a type of software for others to view.

Thus, by combining the first check-in information 15 and the second check-in information 16, the present invention is capable of not only easily completing the travel information, but also confirming time arrangements while viewing positions of tourist attractions, so as to provide others with more accurate time and destination information for viewing and reference. Thus, others may make arrangements directly based on the travel information if it is felt that such travel plans are good.

In the present invention, the check-in module 10 further includes an information input unit 12, and a privacy setting unit 14 electrically connected to the positioning unit 11. The privacy setting unit 14 sets to whom the first check-in information 15 and the second check-in information 16 may be made public to ensure privacy. The information input unit 12 is for a user to input first description information corresponding to the first location information and second description information corresponding to the second location information. For example, the first description information and the second description information may be photographs or text descriptions to increase viewing convenience. The first time point is combined with the first location information and the first description information to form the first check-in information 15; the second time point is combined with the second location information and the second description information to form the second check-in information 16.

The statistics module 30 further includes an input unit 31. A user may input a time range through the input unit 31. After receiving the time interval, the check-in information selecting unit 32 selects the first time point and the second time point within the time range. The statistics module 30 then combines the first check-in information 15 and the second check-in information 16 according to the sequences of the first time point and the second time point to form the travel information.

The present invention further includes a timing unit 13. The timing unit 13 is disposed in the check-in module 10, and includes an interval setting portion 131 for the user to input a time interval. Each time the time interval passes, the interval setting portion 131 controls the positioning unit 11 to capture current location information, such that the first time point and the second time point are separated by the time interval. For example, assuming that the time interval is 15 minutes, the first time point is 8:00 in the morning, and the second time point is 8:15 in the morning, the next time point is then 8:30 in the morning. Thus, the current location information is captured every 15 minutes, and the first check-in information 15 and the second check-in information 16 may then be formed in conjunction with the first time point and the second time point. Further, the timing unit 13 further includes a termination setting portion 132. Once a termination time set on the termination setting portion 132 is reached, the termination setting portion 132 terminates the operations of the interval setting portion 131 to cause the check-in module 10 to stop checking-in.

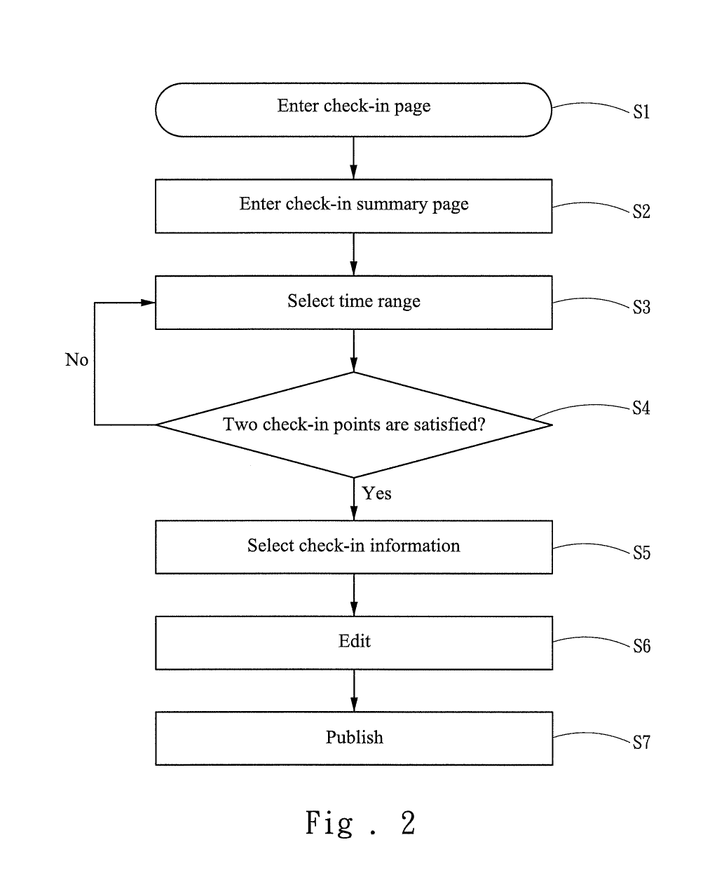

Referring to FIG. 2 to FIG. 3C showing an application process according to a first embodiment of the present invention, user operation steps are described as below.

In step S1, a check-in page is entered to perform check-in. The positioning unit 11 captures the first location information at the first time point, and the first check-in information 15 is formed by the first location information together with the first description information inputted via the information input unit 12. The positioning unit 11 further captures the second location information at the second time point, and the second check-in information 16 is similarly formed by the second location information together with the second description information inputted via the information input unit 12.

In step S2, a check-in summary page is entered. As shown in FIG. 3A, the page shows the input unit 31 for the user to input the time range and the privacy setting unit 14.

In step S3, the time range is selected. A starting time point and an ending time point are inputted via the input unit 31, and options such as public, private and friends viewing may be selected using the privacy setting unit 14.

In step S4, the first check-in information 15 and the second check-in information 16 are stored in the storage module 20, and the system determines whether there are more than two sets of check-in information. Step S5 is performed if so, otherwise step S3 is iterated to again select the time range.

In step S5, check-in information is selected. As shown in FIG. 3B, the first check-in information 15 and the second check-in information 16 required are selected. In this embodiment, three sets of check-in information are selected. The number of sets of selected check-in information needs to be greater than or equal to 2.

In step S6, editing is performed. As shown in FIG. 3C, the statistics module 30 combines the first check-in information 15 and the second check-in information 16 according to the sequences of the first time point and the second time point to form the travel information. Further, associated descriptions, e.g., photographs or text descriptions, may be added to the travel information through the editing module 40.

In step S7, the travel information is published at a type of software. Thus, while allowing others to view positions, photographs and associated text descriptions of tourist attractions, time arrangements are at the same time confirmed to provide more accurate time and destination information.

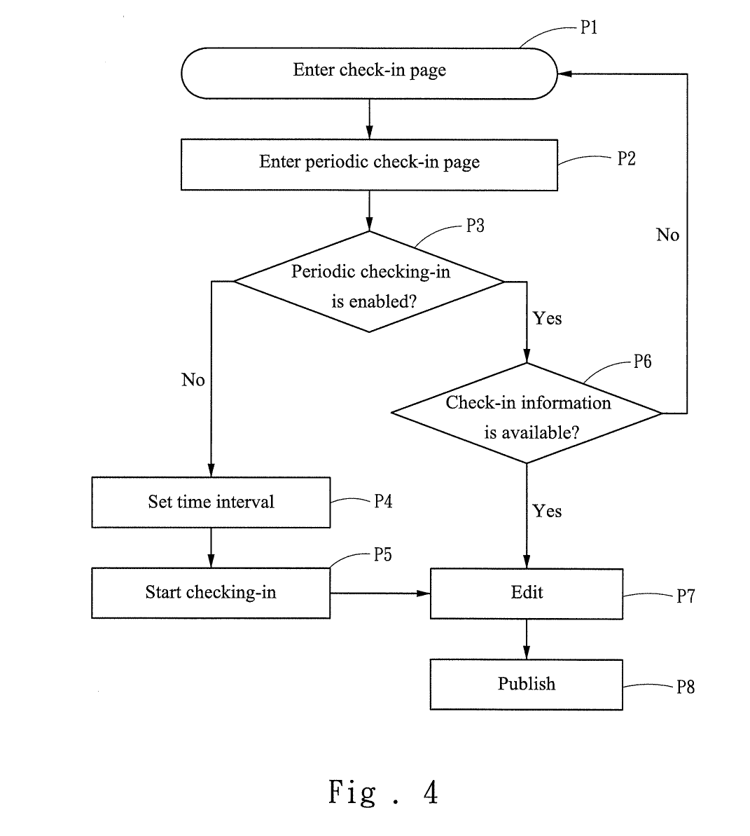

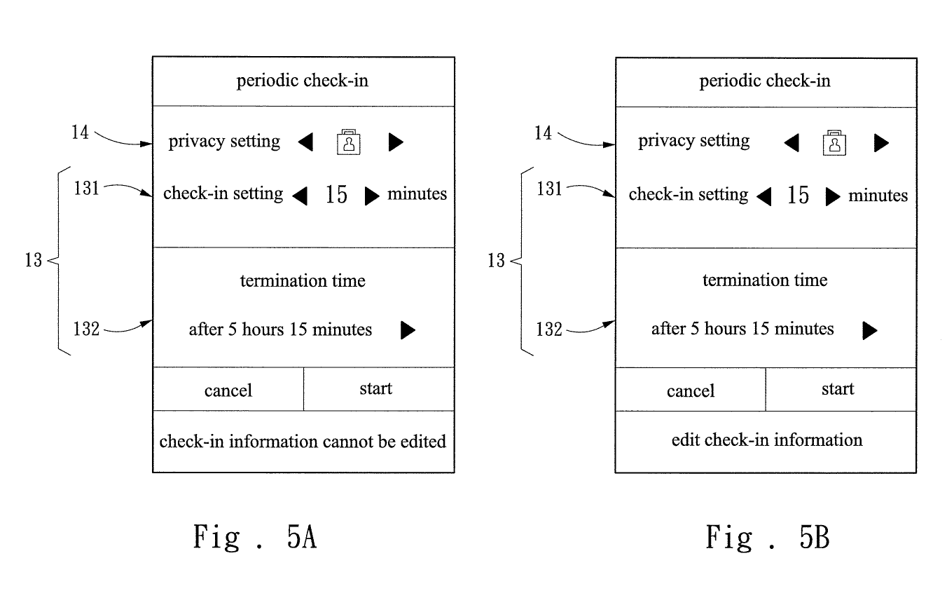

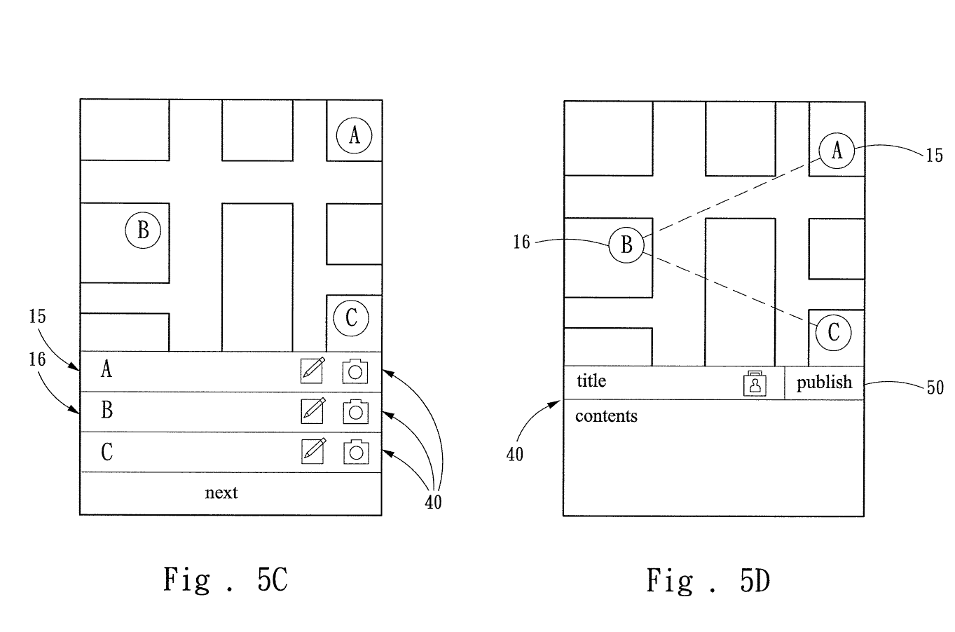

Referring to FIG. 4 to FIG. 5D showing an application process of a second embodiment of the present invention, operation steps are as given below.

In step P1, a check-in page is entered.

In step P2, a periodic check-in page is entered. As shown in FIG. 5A and FIG. 5B, this page includes the interval setting portion 131, the termination setting portion 132 and the privacy setting unit 14.

In step P3, the first check-in information 15 and the second check-in information 16 are stored in the storage module 20, and are for the system to determine whether periodic checking-in is enabled. Step P4 is performed if not, otherwise step P6 is performed.

In step P4, as shown in FIG. 5A, no check-in information is included and available for editing because periodic checking-in is not previously enabled, and so periodic checking-in is enabled. After the user inputs the time interval through the interval setting portion 131 and sets the termination time through the termination setting portion 132, periodic checking-in may then be performed. Further, through the privacy setting unit 14, options of making check-in information public, private or open to friends can be set.

In step P5, each time the time interval passes, the interval setting portion 131 controls the positioning unit 11 to capture current location information. The first time point is combined with the first location information to form the first check-in information 15, and the second time point is combined with the second location information to form the second check-in information 16.

In step P6, periodic checking-in is enable. As shown in FIG. 5B, check-in information is included, and so check-in information may be directly edited.

In step P7, editing is performed. As shown in FIG. 5C and FIG. 5D, the statistics module 30 combines the first check-in information 15 and the second check-in information 16 according to the sequences of the first time point and the second time point to form the travel information. Further, associated information, such as photographs and text descriptions, may be added to the travel information.

In step P8, the travel information is published to a type of software, such that while others view positions, photographs and associated text descriptions of the tourist attractions, time arrangements may be at the same time confirmed to provide more accurate time and location information.

In conclusion, the present invention provides following features.

1. By combining the first check-in information and the second check-in information, the travel information may be easily completed. Thus, while viewing positions of tourist attractions, time arrangements are at the same time confirmed, thereby providing more accurate time and location information for others to browse and refer to.

2. Through the information input unit, photographs or text descriptions may be uploaded to enhance viewing convenience.

3. Using the editing module, associated descriptions, e.g., photographs and texts, may be added to previously published travel information.

4. Using the timing unit, one set of check-in information is automatically formed each time the time interval passes, hence enriching the travel information.

What is claimed is:

1. A multi-point positioning travel recording and planning system, comprising:
a check-in module, comprising a positioning unit, the positioning unit capturing a first location information and a second location information at a first time point and a second time point, respectively, the first time point combined with the first location information to form first check-in information, the second time point combined with the second location information to form second check-in information, the first time point being earlier than the second time point;
a storage module, electrically connected to the check-in module, storing the first check-in information and the second check-in information;
a statistics module, electrically connected to the storage module, comprising a check-in information selecting unit, the check-in information selecting unit selecting the first check-in information and the second check-in information, the statistics module combining the first check-in information and the second check-in information according to sequences of the first time point and the second time point to form travel information;
an editing module, electrically connected to the statistics module, for editing the travel information; and
a publishing module, electrically connected to the editing module, publishing the travel information at a type of software.

2. The multi-point positioning travel recording and planning system of claim 1, wherein the check-in module further comprises an information input unit, the information input unit allowing a user to input first description information corresponding to the first location information and second description information corresponding to the second location information, the first time point combined with the first location information and the first description information to form the first check-in information, the second time point combined with the second location information and the second description information to form the second check-in information.

3. The multi-point positioning travel recording and planning system of claim 1, wherein the check-in module further comprises a timing unit, the timing unit comprises an interval setting portion for a user to input a time interval, the interval setting portion controls the positioning unit to capture current location information each time the time interval passes, such that the first time point and the second time point are spaced by the time interval.

4. The multi-point positioning travel recording and planning system of claim 3, wherein the timing unit further comprises a termination setting portion, and the termination setting portion is configured with a termination time, and causes the interval setting portion to stop operating when the termination time is reached.

5. The multi-point positioning travel recording and planning system of claim 1, wherein the check-in module further comprises a privacy setting unit electrically connected to the positioning unit.

6. The multi-point positioning travel recording and planning system of claim 1, wherein the statistics module further comprises an input unit for a user to input a time range, the check-in information selecting unit receives the time range and selects the first time point and the second time point within the time range, and the statistics module combines the first check-in information and the second check-in information according to sequences of the first time point and the second time point to form the travel information.
